(19) United States
(12) Patent Application Publication
(10) Pub. No.: US 2007/0237425 A1
(43) Pub. Date: Oct. 11, 2007

(54) IMAGE RESOLUTION INCREASING METHOD AND APPARATUS FOR THE SAME

(76) Inventors: Yasunori TAGUCHI, Kawasaki-shi (JP); Takashi IDA, Kawasaki-shi (JP); Nobuyuki MATSUMOTO, Inagi-shi (JP); Hidenori TAKESHIMA, Ebina-shi (JP); Kenzo ISOGAWA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/695,820

(22) Filed: Apr. 3, 2007

(30) Foreign Application Priority Data
Apr. 11, 2006 (JP) 2006-108942

(51) Int. Cl. G06K 9/32

(52) U.S. Cl. 382/299

(57) ABSTRACT

An image resolution increasing method includes reducing an input image, calculating a first feature vector having a feature quantity of a first block of a reduced image, extracting a high-frequency component image from the input image, storing pairs each having the first feature vector and a second block of the high-frequency component image that is located at the same position as the first block as a look-up table, enlarging the input image, calculating a second feature vector having a feature quantity of a third block of an object in the input image, searching the look-up table for the first feature vector similar to the second feature vector, and adding a fourth block of the look-up table which pairs with the first feature vector and a fifth block of the temporal enlarged image that is located at the same position as the third block.

### CROSS-REFERENCE TO RELATED APPLICATIONS

This application is based upon and claims the benefit of priority from prior Japanese Patent Application No. 2006-108942, filed Apr. 11, 2006, the entire contents of which are incorporated herein by reference.

### BACKGROUND OF THE INVENTION

1. Field of the Invention

The present invention relates to a method for generating a super-resolution image to magnify an image and an apparatus for the same.

2. Description of the Related Art

A method of converting a still image of low resolution definition into an image of a super-resolution is disclosed by JP-A 2003-18398 (KOKAI). The method of JP-A 2003-18398 (KOKAI) includes a training stage and a resolution increasing stage. In the training stage, a feature quantity of a m-by-m pixel block of a reduced image obtained by reducing the training image is calculated, and a high-frequency component is generated by extracting the high frequency component of the training image. Subsequently, a plurality of pairs each having a feature vector of a m-by-m pixel block and an N-by-N pixel block in a high-frequency component image located at the same position as the m-by-m pixel block is stored as a look-up table.

In the resolution increasing stage, the input image to be increased in resolution is enlarged by a bilinear method, etc. to generate a temporal enlarged image. The feature vector of a block of m×m pixels of the input image is calculated, and a look-up table is searched for the feature vector similar to the calculated feature vector. The N-by-N pixel block paired with the searched feature vector is added to a block at the same position as a m-by-m pixel block of the input image in a temporary enlarged image. When the above process is performed for all blocks, a super-resolution output image can be generated.

In the conventional method as described above, a super-resolution image is obtained by adding a high-frequency component image generated from the training image to a temporal enlarged image obtained by enlarging the input image.

If a pair of block and feature vector which are generated by the training image of the same kind (letter, face, building, etc.) as the input image to be increased in resolution is stored in a lookup table, a super-resolution image of high picture quality can be provided.

In the method of JP-A 2003-18398 (KOKAI), if the kind (for example, letter, face, building) of training image for creating the lookup table differs from the kind of the input image to be increased in resolution, a super-resolution output image deteriorates in picture quality.

The lookup table has only to be created using various kinds of training image for this problem to be avoided. However, the capacity of the lookup table becomes enormous so that it is not practical.

### BRIEF SUMMARY OF THE INVENTION

An aspect of the invention provides a resolution increasing method of generating a super-resolution output image by resolution-increasing an input image, comprising: reducing an input image to generate a reduced image; calculating a first feature vector having a feature quantity of a first block of the reduced image as an element; extracting a high-frequency component from the input image to generate a high-frequency component image; storing a plurality of pairs each having the first feature vector and a second block of the high-frequency component image that is located at the same position as the first block in a form of a look-up table; enlarging the input image to generate a temporal enlarged image; calculating a second feature vector having a feature quantity of a third block of to-be-processed object in the input image as an element; searching the look-up table for the first feature vector similar to the second feature vector; and adding a fourth block of the look-up table which pairs with the first feature vector and corresponds to the second block (110) and a fifth block of the temporal enlarged image that is located at the same position as the third block to generate a super-resolution output image.

### BRIEF DESCRIPTION OF THE SEVERAL VIEWS OF THE DRAWING

FIG. 1 is a block diagram of a resolution increasing apparatus of a first embodiment.

FIG. 2 is a flow chart showing a resolution increasing process according to the embodiment.

FIG. 3 is a schematic block diagram for explaining a process of a training stage.

FIG. 4 is a schematic block diagram for explaining a process of a resolution increasing stage.

FIG. 5 is a block diagram of a resolution increasing apparatus of a second embodiment.

FIG. 6 is a flow chart showing a resolution increasing process in the second embodiment.

### DETAILED DESCRIPTION OF THE INVENTION

There will now be described the embodiment of the present invention referring to the drawing.

An embodiment to generate an output image by enlarging an input image two times in horizontal and vertical directions will be described. Enlarging magnification does not need to be integer.

An image signal or image data is referred merely to as “image” hereinafter.

### First embodiment

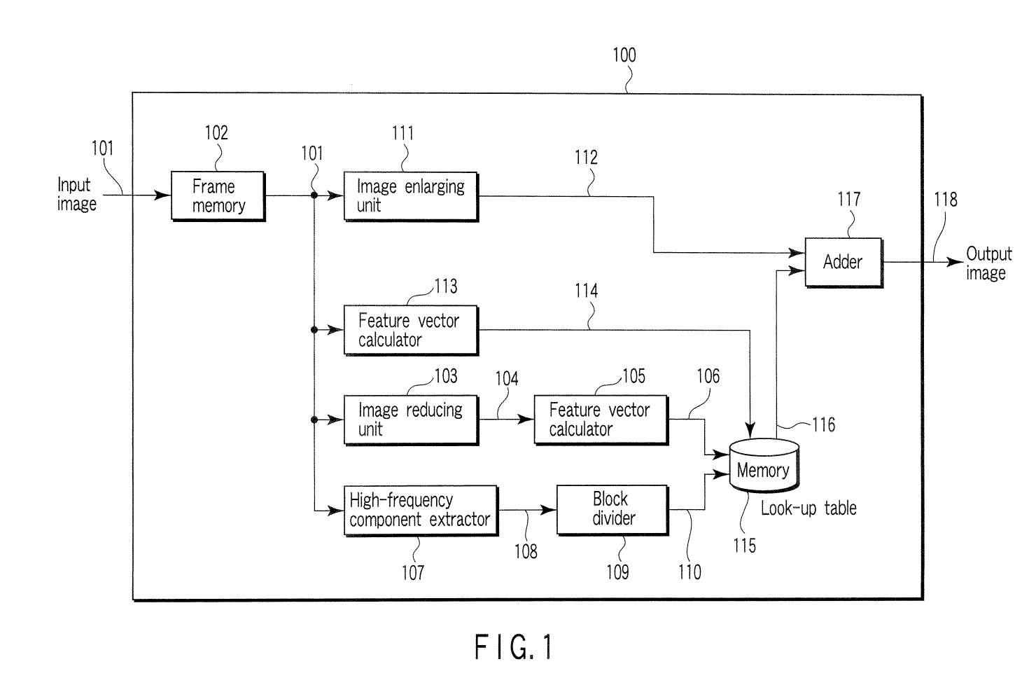

As shown in FIG. 1, an image resolution increasing apparatus 100 according to the first embodiment comprises a frame memory 102 to store temporarily an input image 101, an image reducing unit 103, a first feature vector calculator 105, a high-frequency component extraction unit 107, a block divider 109, an image enlarging unit 111, a second feature vector calculator 113, a memory 115 storing a look-up table and an adder 117.

The input image 101 to be increased in resolution is input to the image reducing unit 103, the second feature vector calculator 113, the high-frequency component extractor 107 and the image enlarging unit 111 in units of frame via the frame memory 102. The image reducing unit 103 reduces the input image 101 to ½ in length and width by a bi-linear method to generate a reduced image 104.

The method of reducing the input image 101 in the image reducing unit 103 may be a method aside from the bi-linear method. It may be, for example, a method such as nearest neighbor method, bi-cubic method, cubic convolution method, cubic spline method, area average method, etc. Alternatively, the image reduction may be carried out by sampling the input image after blurring the input image 101 by a low pass filter. If a high-speed reduction method is used, an image resolution increasing process can be speeded up. If a high quality reduction method is used, the image resolution increasing process itself becomes high quality.

The reduced image 104 is input to the first feature vector calculator 105. Location information of a block of m×m pixels (a m-by-m pixel block) is input to the feature vector calculator 105 sequentially from the controller (not shown). The feature vector calculator 105 calculates a first feature vector 106 having as an element a feature quantity of the m-by-m pixel block of the reduced image 104 indicated by the location information. Concretely, the feature vector 106 is calculated as a vector including an element of a vector (referred to as a block vector) generated by linearly arranging the pixel values of the m-by-m pixel block of the reduced image 104, for example. More specifically, vectors (block vector) are generated by linearly arranging the pixel values of the block of m×m pixels of the reduced image 104. Arranging luminance values, the block vector x is a (m×m) dimension vector. Arranging values of each color of RGB, the block vector x is a (3×m×m) dimension vector. In this way the dimension of the block vector x is changed by condition. Here, the dimension is assumed to be N temporarily. Each element of the vector x is represented by xn (n=1, 2, . . . , N). A vector having at least one element of the vector xn is generated as the feature vector 106. Since the feature vector has only to have at least one element, the vector x itself may be the feature vector 106. The location information of the m-by-m pixel block input to the feature vector calculator 105 sequentially by the controller (not shown) is controlled so that the m-by-m pixel block moves pixel by pixel to, for example, vertical and horizontal directions.

If the feature vector 106 calculated with the first feature vector calculator 105 is a vector generated by arranging linearly feature quantities in the m-by-m pixel block of the reduced image 104, it needs not be a block vector generated by arranging linearly the pixel values. For example, the vector x is generated as described above. Subsequently, an average of all elements of the vector x is calculated. The average is subtracted from each element. The vector is normalized so that dispersion of vector of the subtraction result becomes 1. The vector is expressed by x anew, and each element of the vector x is represented by xn (=1, 2, . . . , N).

A vector having at least one element within the vector xn is generated. The vector is assumed to be an input vector 106. Since the vector has only to have at least one element, the vector x itself may be the feature vector 106. In other words, the feature vector 106 can be generated as a vector including an element of a vector generated so that an average of elements of the block vector is 1 and dispersion thereof is 0.

The feature vector 106 may be a vector including an element of a vector obtained by dividing a vector generated by arranging linearly the pixel values of the m-by-m pixel block of the high-frequency component of the reduced image 104. In other word, y is assumed to express a vector generated by arranging linearly pixel values of a m-by-m pixel block of an image generated by extracting high-frequency components from the reduced image 104. It should be noted that the high-frequency components include no luminance value and color values of RGB.

Norm ||y|| of y is calculated from y. y wants to be divided by ||y||, but when ||y||=0, y cannot be divided by ||y||. For this reason, a small value is added to ||y|| beforehand. The small value is assumed to be z. y is divided by ||y||+z. The vector obtained by division is assumed to be the feature vector 106. The feature vector 106 may be a vector including another feature quantity additionally. As a result, there can be obtained a picture quality near to that of the image obtained when a large number of pairs are generated from a training image which is the same kind (letter, face, building) as the input image 101 but aside from the input image 101.

The high-frequency component extractor 107 extracts a high-frequency component from the input image 101 to generate a high-frequency component image 108. Concretely, the high-frequency component extractor 107 generates the high-frequency component image 108 by reducing the input image 101 to ½ in length and breadth by a bi-linear method, and subtracting the image obtained by enlarging the reduced input image 101 to 2 times in vertical and horizontal directions from the input image 101. Alternatively the high-frequency component may be extracted by subjecting the input image 101 to highpass filtering.

The high-frequency component image 108 generated with the high-frequency component extractor 107 is input to a block divider 109. The same location information of m-by-m pixel block as the location information send from the controller (not shown) to the feature vector calculator 105 is input to the block divider 109 sequentially. The block divider 109 outputs a high-frequency component block (second block) 110 which is a block of N pixels×N pixels located at the same position as that of the m-by-m pixel block of the high-frequency component image 108.

The image enlarging unit 111 generates a temporal enlarged image 112 by enlarging the input image 101 to two times in vertical and horizontal directions by bi-linear method. The temporal enlarged image 112 is a temporary enlarged image before generating an output image (enlarged image) 118 of a super-resolution finally.

The image enlarging unit 111 may use an image enlarging method other than the bi-linear method to enlarge the input image 101. It may be, for example, an interpolation method such as nearest neighbor method, bi-cubic method, cubic convolution method, cubic spline method. If a high-speed interpolation method is used, an image resolution increasing process can be increased in speed. If a high quality interpolation method is used, the image resolution increasing process itself is improved in quality.

The second feature vector calculator 113 is supplied with location information of the m-by-m pixel block from the controller (not shown) as the first feature vector calculator 105. The second feature vector (input vector) 114 having a feature quantity of the m-by-m pixel block (third block) of the input image 101 indicated by this location information is calculated. Concretely, the input vector 114 is calculated as a vector including an element of a vector (block vector) arranging linearly pixel values of a m-by-m pixel block of the input image 101, for example. More specifically, the vectors are generated by linearly arranging the pixel values of a block of m×m pixels of the input image 101. The vectors are referred to as a block vector. Arranging luminance values, the block vector x is a (m×m) dimension vector. Arranging values of each color of RGB, the block vector x is a (3×m×m) dimension vector.

In this way, the dimension of the block vector x is changed according to condition. Here, the dimension is assumed to be N temporarily. Each element of the vector x is represented by xn (n=1, 2, . . . , N). A vector having at least one element of the xn is generated as the input vector 114. Since the feature vector has only to have at least one element, the vector v itself may be the input vector 114.

In this case, location information of the m-by-m pixel block input from the controller to the feature vector calculator 113 sequentially is controlled so as to cover the input image 101 according to movement of the m-by-m pixel block.

If the feature vector (input vector) 114 calculated with the second feature vector calculator 113 is a vector generated by arranging linearly feature quantities of the m-by-m pixel block of the input image 101, it needs not be a block vector. For example, the input vector 114 can be generated as a vector including an element of a vector generated so that an average of the pixel values of the m-by-m pixel block is 1 and dispersion thereof is 0. In other words, the vector x is generated as described above. Subsequently, an average of all elements of the vector x is calculated and is subtracted from each element. The vector is normalized so that dispersion of vector of the subtraction result becomes 1. The vector is expressed by x anew, and each element of the vector x is represented by xn (=1, 2, . . . , N). A vector having at least one element within the elements xn is generated. The vector is assumed to be the input vector 114. Since the vector has only to have at least one element, the vector x itself may be the input vector 114.

Further, the input vector 114 may be a vector including an element of a vector obtained by dividing a vector generated by arranging linearly the pixel values of the m-by-m pixel block by a value (assumed to be v) obtained by adding a small value to the norm of the vector. More specifically, y is assumed to express a vector generated by arranging linearly pixel values of a m-by-m pixel block of an image generated by extracting high-frequency components from the input image 101. It should be noted that the high-frequency components include no luminance value and color values of RGB.

Norm ||y|| of y is calculated from y. y wants to be divided by ||y||, but when ||y||=0, y cannot be divided by ||y||. For this reason, a small value is added to ||y|| beforehand. The small value is assumed to be z. y is divided by ||y||+z. The vector obtained by division is assumed to be the input vector 114. The input vector 114 may be a vector including another feature quantity additionally. As a result, there can be obtained a picture quality near to that of the image obtained when a large number of pairs are generated from a training image which is the same kind (letter, face, building) as the input image 101 but aside from the input image 101.

The first feature vector 106 calculated with the first feature vector calculator 105, the high-frequency component block 110 output from the block divider 109 and the second feature vector (input vector) 114 calculated with the second feature vector calculator 113 are input to the memory 115. When the feature vector 106 and the high-frequency component block 110 are input to the memory 115, a pair of them (a pair of the feature vector 106 and the high-frequency component block) is stored in the memory 115 as an element of the look-up table. When the input vector 114 is input to the memory 115, a feature vector nearest to the input vector 114 is searched from the feature vectors 106 in the look-up table. Further, the high-frequency component block 110 pairing with the feature vector 106 searched from the look-up table is output as an addition block 116.

The first feature vector having a minimum distance with respect to the feature vector 114 is selected as a vector most similar to the input vector 114 in the feature vectors 106. It is preferable that a L1 distance (Manhattan distance) is used for an inter-vector distance used for searching the look-up table. However, it is not limited thereto, but may be a L2 distance (Euclidean distance), a L∞ distance, a weighted L1 distance, a weighted L2 distance or a weighted L∞ distance or other distance. The weighting factor is set at a value increasing with an increase of the norm of input vector 114. Therefore, the feature vector near the input vector 114 is searched from the feature vectors 106 in the look-up table. This increases the picture quality of the output image 118 with high resolution.

In the embodiment, the feature vector nearest to the input vector is searched, but it does not always need to be the nearest vector. For example, if the search process is terminated when the feature vector is found at a position near a given distance from the input vector 114, a search time can be shortened. This shortens the processing time of image resolution increasing process.

The temporal enlarged image 112 and addition block 116 are input to the adder 117. The same location information of m-by-m pixel block as that sent to the feature vector calculator 113 from the controller (not shown) is input to the added 117 sequentially. The addition block 116 of N×N pixels is added to the fourth block at the same position as that indicated by the location information of the temporal enlarged image 112.

When the feature vector 106 is a vector obtained by dividing a first vector by a value obtained by adding a small value to the norm of the first vector with the first feature vector calculator 105, and when the input vector 114 is a vector obtained by dividing a second vector by a value (assumed to be z) obtained by adding a small value to the norm of the second vector with the second feature vector calculator 113, an addition block 116 is added to the fourth block of the temporary enlarged image 112. The first vector is generated by linearly arranging the pixel values of the m-by-m pixel block of the reduced image 104, and the second vector is generated by arranging linearly the pixel values of the m-by-m pixel block of the high-frequency components of the input image 104. The addition block 116 is generated by multiplying each element of the high-frequency component block 110 paring with the feature vector 106 searched from the look-up table by z. When the above process is finished for all blocks of the input image 101, a high-resolution output image 118 is generated.

When a distance between the searched feature vector 106 and the input vector 114 is larger than a threshold, the adder 117 needs not add the high-frequency component block 110 pairing with the searched feature vector 106, namely addition block 116 to the temporary enlarged image 112. In other words, only when the feature vector 106 that the distance with respect to the input vector 114 is more than the threshold is searched for at the time of searching the look-up table, the adder 117 adds the high frequency block 110 used as an addition block to the fourth temporary enlarged image 112. As a result, when the input vector 114 and the feature vector 106 similar thereto are not stored as a look-up table in the memory 115, an unnatural output image 118 is not generated, because the adder block 116 is not added to the temporal enlarged image 112.

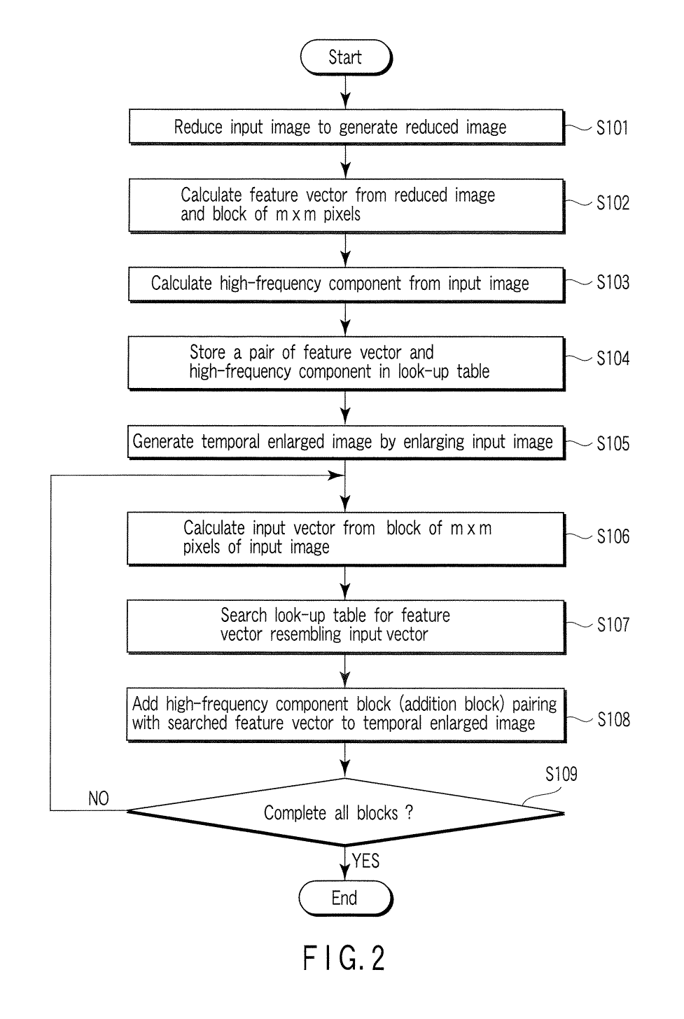

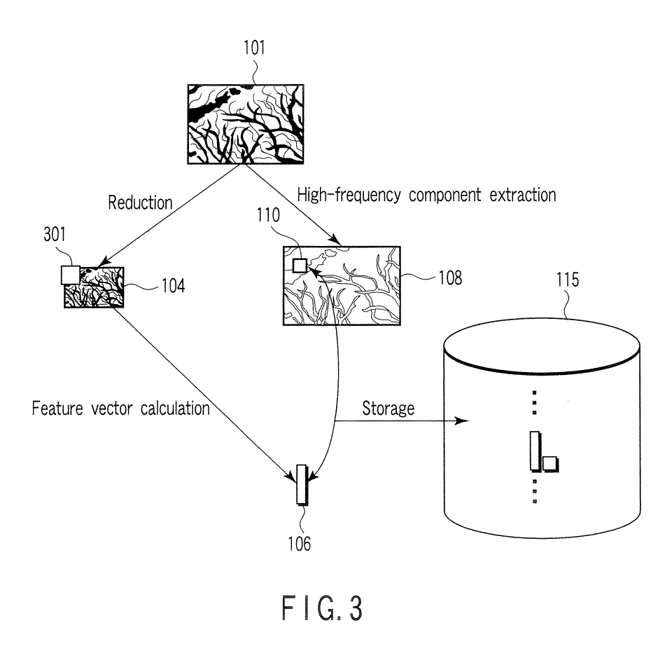

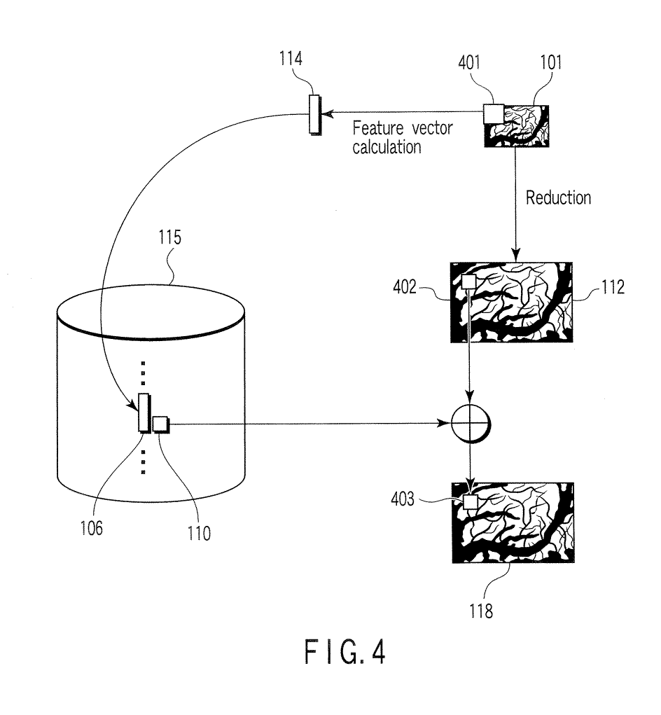

An image resolution increasing process according to the present embodiment is described in detail with reference to FIGS. 2, 3 and 4. FIG. 3 represents a process of training stage of steps S101 to S104 of FIG. 2. FIG. 4 represents a process of resolution increasing stage of steps S105 to S109 of the resolution increasing process of FIG. 2.

<Step S101> The reduced image 104 is generated by reducing the input image 101 in the image reducing unit 103.

<Step S102> The first feature vector 106 having a feature quantity of a m-by-m pixel block (first block) 301 of the reduced image 104 in an element is calculated in the first feature vector calculator 105.

<Step S103> The high-frequency component of the input image 101 is extracted with the high-frequency component extractor 107 to generate a high-frequency component image 108.

<Step S104> A plurality of pairs each including the first feature vector 106 and a N×N high-frequency component block (second block) 110 located at the same position as the m-by-m pixel block from which the feature vector 106 of the high-frequency component image 108 is calculated are stored as a look-up table in the memory 115. In this step S104, a process of storing as an element of the look-up table a pair other than the pair of feature vector 106 and high-frequency component block 110 may be done. As a result, since more pairs are stored, a picture quality of the resolution increasing output image 118 becomes high.

<Step S105> The temporary enlarged image 112 is generated by enlarging the input image 101 with the image enlarging unit 111.

<Step S106> The second feature vector (input vector) 114 having a feature quantity of m-by-m pixel block (third block) 401 of the input image 101 as an element is calculated with the second feature vector calculator 113.

<Step S107> The feature vector 106 having the shortest distance with respect to the input vector 114 is searched from the look-up table stored in the memory 115.

<Step S108> The adder 117 adds the high-frequency component block 110 paring with the searched feature vector 106, namely the addition block 116 to the fourth block in the temporal enlarged image 112 to generate an output block 403 becoming a structure element of the output image 118.

<Step S109> In the controller which is not illustrated, if the above process is finished for all blocks of the input image 101, the resolution increased output image 118 is output and the process terminates. If all blocks are not processed, the process returns to step 106.

As mentioned above, by using the input image 101 to be increased in resolution as a training image at the time when a look-up table is made in the memory 115, the kind (letter, face, building) of the input image becomes the same as that of the input image necessarily. Accordingly, picture quality deterioration of the super-resolution output image 118 can be avoided without increasing capacity of the look-up table greatly.

Since a serial process of training stage and resolution increasing stage is executed after input of the input image 101, there is an advantage that a look-up table dedicated ROM is not needed to be prepared specially.

### Second embodiment

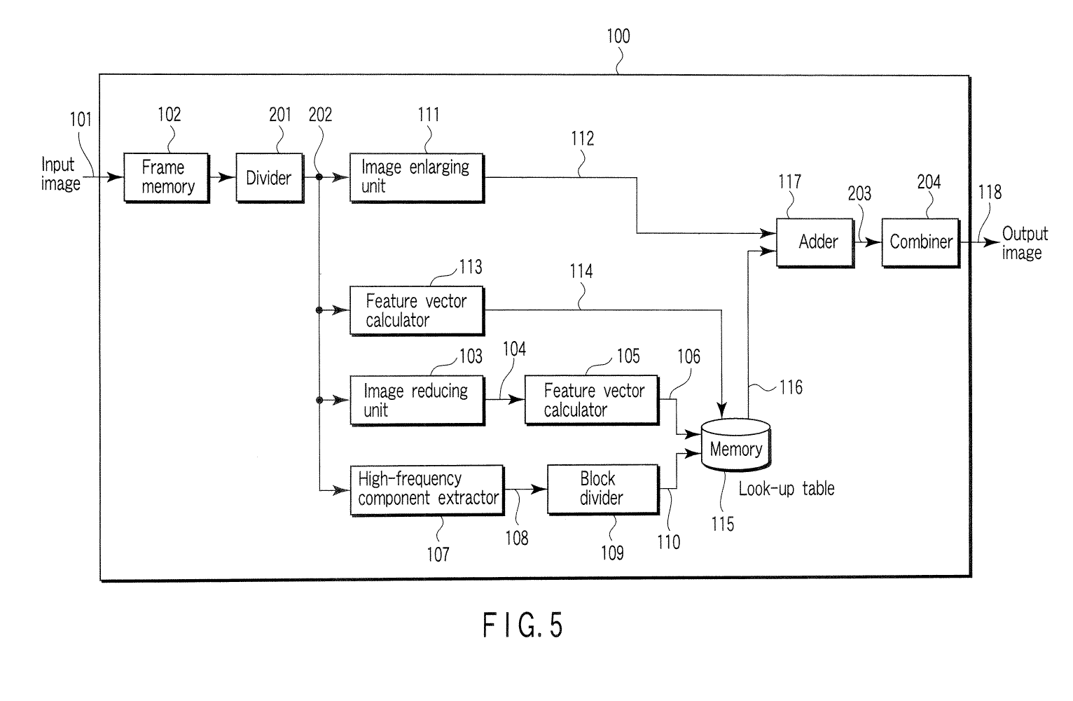

FIG. 5 shows a resolution increasing apparatus according to the second embodiment. Explaining only difference with respect to FIG. 1, the input image 101 is input to a divider 201 via a frame memory 102. The divider 201 divides the input image 101 to subregions of, for example, ¼ size, and outputs four divided images 202 sequentially or at the same time. The divided pictures 202 are sent to an image enlarging unit 111, a feature vector calculator 113, an image reducing unit 103 and a high-frequency component extraction unit 107.

The image enlarging unit 111, feature vector calculator 113, image reducing unit 103 and high-frequency extraction unit 107 to which the divided images 202 are input process the divided images 202 instead of the input image 101. The adder 117 generates not a super-resolution output image, but, for example, four divided super-resolution images 203 corresponding to the divided images 202 of the input image 101. A combiner 204 combines the divided super-resolution images 203 to generate a super-resolution output image 118.

In the present embodiment, since four divided images 202 are sent to each of the image enlarging unit 111, feature vector calculator 113, image reducing unit 103 and high-frequency component extraction unit 107, each of them carries out the same process four times according to the processing order controlled by the controller (not shown).

Meanwhile, a pair of feature vector and block generated by each of four divided images 202 is stored in from of a look-up table in a memory 115, but the already stored pair may be erased or added every time that each divided image 202 is processed. If it is erased, the number of pairs stored as elements of the look-up table in the memory decreases. Accordingly, calculation amount for search in step S107 of FIG. 2 is reduced.

Even if the divided image is not erased, comparing with the case that the image is not divided, the number of pairs stored in the memory as elements of the look-up table is fewer in comparison with the case that the image is not divided. Therefore, the calculation amount for search in step S107 is decreased just the same.

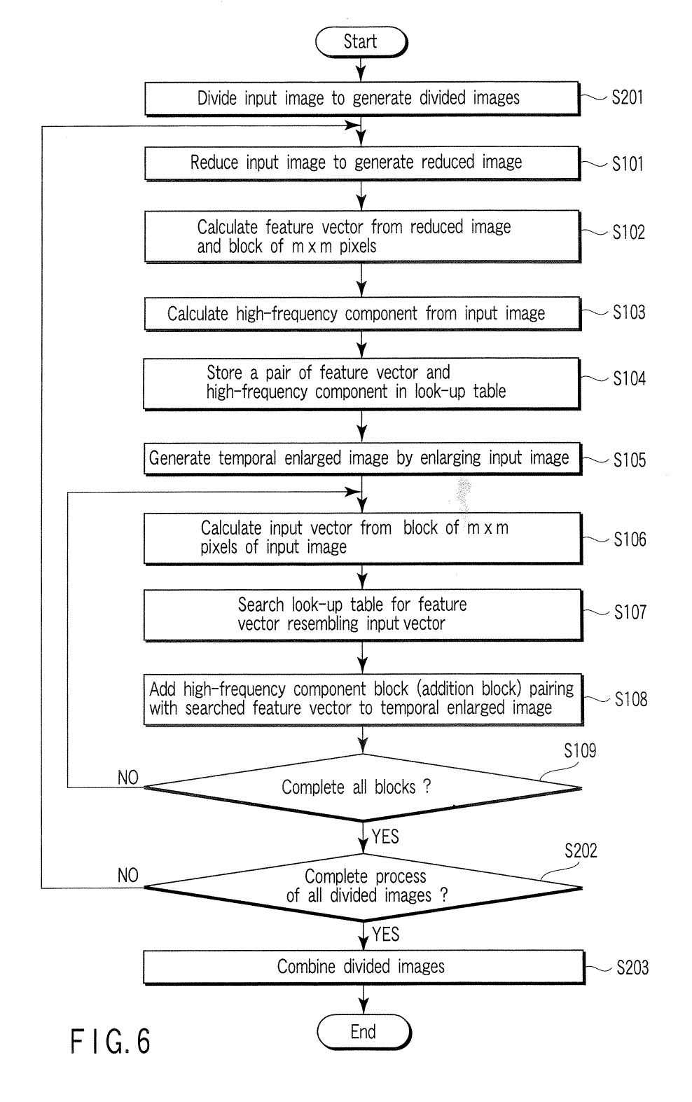

In the second embodiment, since the configuration of the resolution increasing apparatus is changed, the process flow also is changed as shown in FIG. 6. Explaining points changed from FIG. 2, step S201 is inserted before step S101, and steps S202 and 203 are inserted after step 9. In step S201, the divider 201 divides the input image 101 into divided images 202. The process of steps S101 to S108 is carried out not for the input image 101 but for the divided images 202.

In step S202, if the process for all four divided images 202 is finished, the process advances to step S203. If all four divided images 202 are not completed, the process advances to step S101. In step S203, the combiner 204 combines four divided super-resolution images 203 and outputs a super-resolution output image 118.

Further, a step of erasing a pair stored as an element of the look-up table may be inserted in the process flow of FIG. 6.

In the above embodiment, the input image 101 is divided into four divided images, but it needs not to be always divided into four. The input image 101 may be divided into, for example, subregions of a specific shape such as a rectangle, and into subregions every object. When it is divided into smaller subregions, the number of pairs stored as elements of the look-up table in the memory 115 decreases resulting in increasing a processing speed. When it is divided into subregions every object, the picture quality of super-resolution output image 118 is improved because a kind (letter, face, building) of divided images becomes the same as a kind (letter, face, building) of the training image.

FIGS. 1 and 5 show the feature vector calculator 105 and the feature vector calculator 113 independently, but the first feature vector 106 and the second feature vector (input vector) 114 can be calculated with a common feature vector calculator if the input and output of the common feature vector calculator are controlled by the controller (not shown). As a result, the resolution increasing apparatus is decreased in size.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A resolution increasing method of generating a super-resolution output image by resolution-increasing an input image, comprising:
reducing an input image to generate a reduced image;
calculating a first feature vector having a feature quantity of a first block of the reduced image as an element;
extracting a high-frequency component from the input image to generate a high-frequency component image;
storing a plurality of pairs each having the first feature vector and a second block of the high-frequency component image that is located at the same position as the first block in form of a look-up table;
enlarging the input image to generate a temporal enlarged image;
calculating a second feature vector having a feature quantity of a third block of to-be-processed object in the input image as an element;
searching the look-up table for the first feature vector similar to the second feature vector; and
adding a fourth block of the look-up table which pairs with the first feature vector and corresponds to the second block and a fifth block of the temporal enlarged image that is located at the same position as the third block to generate a super-resolution output image.

2. An image resolution increasing method comprising:
dividing an input image into a plurality of subregions to generate a plurality of divided images;
reducing the divided images to generate a plurality of reduced images;
calculating a first feature vector having a feature quantity of a first block of each of the reduced images as an element;
extracting a high-frequency component from each of the divided images to generate a high-frequency component image;
storing a plurality of pairs each having a second block of the high-frequency component image that is located at the same position as the first block and the first feature vector in a form of a look-up table;
enlarging each of the divided images to generate an enlarged image;
calculating a second feature vector having a feature quantity of a third block of an object to be processed in the divided image as an element;
searching the first feature vector similar to the second feature vector from the lookup table;
adding a second block in the lookup table which pairs with the searched first feature vector to a fourth block in the temporal enlarged image which is located at the same position as the third block to generate super-resolution divided images; and
combining the super-resolution divided images to generate an output image.

3. The method according to claim 1, wherein the storing includes storing a pair of block and feature vector other than the pairs in the look-up table.

4. The method according to claim 1, wherein the reducing includes reducing the input image or the divided image by an interpolation manner, an area averaging manner or a subsampling manner.

5. The method according to claim 1, wherein the enlarging includes enlarging the input image or the divided image by an interpolation manner.

6. The method according to claim 1, wherein the calculating the first feature vector or the calculating the second feature vector includes containing an element of a block vector generated by linearly arranging pixel values of the first block or a vector set so that an average of elements of the block vector is 0, and dispersion thereof is 1.

7. The method according to claim 1, wherein the calculating the first feature vector includes calculating as the first feature vector a vector including an element of a vector obtained by dividing a first vector by a first value obtained by adding a small number to norm of the first vector, the first vector being generated by linearly arranging pixel values of the first block,
the calculating the second feature vector includes calculating as the second feature vector a vector including an element of a vector obtained by dividing a second vector by a second value obtained by adding a small number to norm of the first vector, the second vector being generated by linearly arranging pixel values of the third block, and
the adding includes adding each element of the fourth block of the look-up table which pairs with the searched first feature vector to the fifth block including elements each multiplied with the second value.

8. The method according to claim 1, wherein the searching includes calculating a distance between the first feature vector and the second feature vector, and searching for a first vector of the first vectors of the look-up table which corresponds to a short relative distance between the first feature vector and the second feature vector.

9. The method according to claim 1, wherein the calculating the first feature vector includes calculating as the first feature vector a vector including an element of a vector obtained by dividing a first vector by a first value obtained by adding a small number to norm of the first vector, the first vector being generated by linearly arranging pixel values of the first block,
the calculating the second feature vector includes calculating as the second feature vector a vector including an element of a vector obtained by dividing a second vector by a second value obtained by adding a small number to norm of the first vector, the second vector being generated by linearly arranging pixel values of the third block, and
the searching includes calculating a distance between the first feature vector and the second feature vector, the distance being weighted by a weighting factor increasing with increase of the norm, and searching for a first vector of the first vectors of the look-up table which corresponds to a short relative distance between the first feature vector and the second feature vector.

10. The method according to claim 1, wherein the adding includes adding the second block to the fifth block only when the first feature vector indicating a distance more than a threshold with respect to the second feature vector is searched in the searching.

11. The method according to claim 1, wherein the dividing includes dividing the input image into specific shape regions of the input image or object regions of the input image.

12. An image resolution increasing apparatus for generating a super-resolution output image by resolution-increasing an input image, comprising:
a dividing unit configured to divide an input image into a plurality of subregions to generate a plurality of divided images;
a reducing unit configured to reduce an input image to generate a reduced image;
a first calculator unit configured to calculate a first feature vector having a feature quantity of a first block of the reduced image as an element;
an extracting unit configured to extract a high-frequency component from the divided image to generate a high-frequency component image;
a memory unit configured to store a plurality of pairs each having a second block of the high-frequency component image that is located at the same position as the first block and the first feature vector in a form of a look-up table;
an enlarging unit configured to the input image to generate a temporal enlarged image;
a second calculator unit configured to calculate a second feature vector having a feature quantity of a third block of an object to be processed in the input image as an element;
a searching unit configured to search the lookup table for the first feature vector similar to the second feature vector;
an adder unit configured to add a second block in the lookup table which pairs with the searched first feature vector to a fourth block in the temporal enlarged image which is located at the same position as the third block.

13. An image resolution increasing apparatus for generating a super-resolution output image by resolution-increasing an input image, comprising:
a divider unit configured to divide an input image into a plurality of subregions to generate a plurality of divided images;
a reducing unit configured to reduce the divided images to generate a plurality of reduced images;
a first calculator unit configured to calculate a first feature vector having a feature quantity of a first block of each of the reduced images as an element;
an extractor unit configured to extract a high-frequency component from each of the divided images to generate a high-frequency component image;
a memory unit configured to store a plurality of pairs each having a second block of the high-frequency component image that is located at the same position as the first block and the first feature vector in a form of a look-up table;
an enlarging unit configured to enlarge each of the divided images to generate an enlarged image;
a second calculator unit configured to calculate a second feature vector having a feature quantity of a third block of an object to be processed in the divided image as an element;
a searching unit configured to search the look-up table for the first feature vector similar to the second feature vector;
an adder unit configured to add a second block in the lookup table which pairs with the searched first feature vector to a fourth block in the temporal enlarged image which is located at the same position as the third block to generate super-resolution divided images; and
a combining unit configured to combined the super-resolution divided images to generate an output image.

14. A computer readable storage medium storing instructions of a computer program which when executed by a computer results in performance of steps comprising:
reducing an input image to generate a reduced image;
calculating a first feature vector having a feature quantity of a first block of the reduced image as an element;
extracting a high-frequency component from the input image to generate a high-frequency component image;
storing a plurality of pairs each having the first feature vector and a second block of the high-frequency component image that is located at the same position as the first block in a form of a look-up table;
enlarging the input image to generate a temporal enlarged image;
calculating a second feature vector having a feature quantity of a third block of to-be-processed object in the input image as an element;
searching the look-up table for the first feature vector similar to the second feature vector; and
adding a fourth block of the look-up table which pairs with the first feature vector and corresponds to the second block and a fifth block of the temporal enlarged image that is located at the same position as the third block to generate a super-resolution output image.

15. A computer readable storage medium storing instructions of a computer program which when executed by a computer results in performance of steps comprising:
dividing an input image into a plurality of subregions to generate a plurality of divided images;
reducing the divided images to generate a plurality of reduced images;
calculating a first feature vector having a feature quantity of a first block of each of the reduced images as an element;
extracting a high-frequency component from each of the divided images to generate a high-frequency component image;
storing a plurality of pairs each having a second block of the high-frequency component image that is located at the same position as the first block and the first feature vector in a form of a look-up table;
enlarging each of the divided images to generate an enlarged image;
calculating a second feature vector having a feature quantity of a third block of an object to be processed in the divided image as an element;
searching the first feature vector similar to the second feature vector from the lookup table;
adding a second block in the lookup table which pairs with the searched first feature vector to a fourth block in the temporal enlarged image which is located at the same position as the third block to generate super-resolution divided images; and
combining the super-resolution divided images to generate an output image.
